(19) United States
(12) Patent Application Publication
(10) Pub. No.: US 2019/0344883 A1
(43) Pub. Date: Nov. 14, 2019

(54) ELECTRIC DRIVE SYSTEM OF GYROPLANE

(71) Applicant: Pavel BREZINA, Zlin (CZ)

(72) Inventor: Pavel BREZINA, Zlin (CZ)

(21) Appl. No.: 16/474,901

(22) PCT Filed: Dec. 22, 2017
(86) PCT No.: PCT/CZ2017/050064

§ 371 Date: Jun. 28, 2019

(30) Foreign Application Priority Data
Dec. 29, 2016 (CZ) PV 2016-840

(51) Int. Cl. B64C 27/02; B64C 37/00

(52) U.S. Cl. CPC B64C 27/02; B64C 25/34; B64C 37/00

(57) ABSTRACT

An electric drive system of a gyroplane (28) includes a support rotor (11), a primary engine (7) connected with a pusher propeller (8) for movement in air, and an electric motor (1) for movement on road. The primary engine (7) is connected by means of a mechanical gear to an alternator (6), which is coupled with a charger (5), which is further connected to a traction battery (3). The traction battery (3) is bi-directionally connected with a Battery Management System (4), and the traction battery (3) is further electrically connected with a regulator (2) and a control unit (9), the regulator (2) being further connected with the electric motor (1) mounted adjacent to a driven road wheel (12) which is driven by the electric motor (1).

### TECHNICAL FIELD

The invention relates to an electric drive system of a gyroplane comprising a primary engine connected with a support rotor for movement in air and a secondary motor for movement on the road, wherein the gyroplane is further provided with safety means for its movement on the road.

### STATE OF THE ART

In present, gyroplanes are manufacture mainly for transportation of people, most often two passengers. The gyroplane is propelled forwards by means of a combustion engine or a pusher propeller. In contrast to helicopter, the gyroplane is uplifted by means of a rotor, which is rotated by air pushing the rotor blades when the gyroplane moves forwards. During flight, gyroplanes are capable of skillful maneuvers and excel in high safety. On the ground, the gyroplane must be moved manually or by means of a motor and pusher propeller. The pusher propeller is, of course, not covered and thus poses danger for the surroundings. Air flow behind the pusher propeller should also be considered dangerous. Therefore, it is impossible to use a gyroplane on the road legally, although its dimensions would allow this.

Patent application no. US 2016052624 describes a system for restoring mobility of an aircraft. The aircraft is provided with at least one own self-propelled drive wheel, controlled by driver for driving on a roadway. The drive of the drive wheel may be a high phase order electric motor or an electric induction motor with permanent magnets, a brushless DC motor, switched reluctance motor, hydraulic motor or a pneumatic motor.

Patent application no. US 20160159470 describes a method for increasing aircraft effective value, characterized in that the propelled wheels are provided with a drive for its autonomous movement on the ground, without using the main aircraft engines or external tow vehicles. The drive for autonomous movement is mounted so that it drives one or more aircraft wheels. This drive system for driven aircraft wheels is controlled by the pilot and allows movement of the aircraft on the ground independently from the main engines. The drive of the driven wheel is designed so as to reduce aircraft operation costs when moving on the runway and increase savings for aircraft operation.

Modular vehicle structure described in US patent application no. US2013168489 allows adapting the vehicle for flying. The structure includes a wing, which may be removed, tilted, rotated, controller or “locked in” place, for various operation methods as well as various needs of customers. The wing rotating by means of a NACA 23112 profile provides longitudinal stability thanks to changes of wing settings or power. The wing may be also “locked” so as to provide conventional vehicle type control. The wings are tilted for driving on the ground or they may be removed. Horizontal stabilizer provides balance and stability for balancing the vehicle in order to provide comfort to passenger and for optimal landing. The trunk consists of three main modules, the main central module consisting of a motor, a gearbox, wings and a loading spaces, further the front and rear modules, which may comprise one or two wheels or may be further provided with a motor or no motor.

A road vehicle, such as a motor car with alternative arrangement, thanks to which it may be used as a plane, is described in CA795663 (A). The vehicle comprises a vehicle body, support wing, attachment means for attaching the support wing to the vehicle body and means for folding down the said wing when driving on the ground. The folding means for the wing may further comprise additional means for tilting the vehicle in order to change the angle of impact of the said wing. These tilting means include a control element, by means of which a rear wheel carrying the said vehicle may be moved so as the front part of the body to tilt backwards in a predetermined range.

An aircraft with folding wings and means for driving the landing wheels intended for movement on the ground, consisting of two engines, wherein one engine drives the propeller and the other engine drives the driving wheels, is described in GB143591. The propeller is driven by the engine, which may be started with the second engine. The second engine is adapted to drive the landing wheels through gear wheels, universal gears, cardan shaft, differential gear ratio, or through a tooted chain. The casings of the axle wheels are connected by means of adjustable brackets or radius arms with a differential housing and movement of the wheels is realized along the arc around the differential gear wheel, wherein their movement is limited by the clamps on the brackets. The steering is performed using arms, which are controlled in the cockpit by means of wires connected to the arms on the vertical spindle.

The aim of the invention is to provide an electric drive system of a gyroplane, allowing gyroplanes to ride in a traffic. For this purpose, they are provided with means and devices which allow their movement on the public roads. This is achieved by implementing an electric motor for movement on the ground, which is at least partially independent from the primary engine driving the pusher propeller, wherein the electric motor is arranged on at least one travelling wheel.

### SUMMARY OF THE INVENTION

The above mentioned aim according to the present invention is achieved by means of an electric drive system of a gyroplane comprising a support motor and a primary engine connected with a pusher propeller for movement in air and an electric motor for movement on the roads, characterized in that the primary engine is connected by means of a mechanical gear to an alternator, which is coupled with a charger, which is further connected to a traction battery, wherein the traction battery is bi-directionally connected with a Battery Management System, wherein the traction battery is further electrically connected with a regulator and a control unit, while the regulator is further connected with the electric motor, mounted on a driven wheel of the chassis.

In order to allow the gyroplane to legally move on the road, the electric drive system of a gyroplane has the primary engine connected with the pusher propeller by means of a detachable coupling. The connection allows detaching the pusher propeller from the primary engine after landing or after gyroplane enters the road, wherein the primary engine remains still in operation and generates electric energy for electric motor.

Part of the traction battery is a “Battery Management System”, which is an integral system of control units and modules, monitoring the operation states of the battery in order to provide security. The operation states are controlled by means of measurable values, such as, for example, temperature and battery cell voltage. Moreover, in case of risk of battery damage, the Battery Management System is capable to securely disconnect the battery from operation of the electric drive system of a gyroplane.

For easily manipulation and simple maintenance of the electric drive system, the electric motor is arranged on a support structure of the driven travelling wheel. The torque moment is transferred from the electric motor to the driven travelling wheel through pulley or chain.

In order to achieve the best travelling properties of the gyroplane, the electric motor may be arranged in the axis which is common for the electric motor as well as for the driven travelling wheel. In this preferred embodiment, the torque moment is transferred from the electric motor to the driven travelling wheel by means of simple gears in 1:1 ratio or by means of a planetary gearbox.

To reduce aerodynamic resistance and to protect the driven travelling wheel and the electric motor against outer mechanical damages, these components are housed in a casing.

Advantage of the present solution is the fact that it allows implementation of the electric drive for one or more gyroplane chassis wheels, and moreover, it is possible to arrange elements of safety equipment, necessary for operation on the roads, on the structure of the gyroplane. The safety equipment includes especially homologated lights, license plate holders, rearview mirrors, wipers, reflectors, horns and other accessories. The electric motor and safety equipment elements may be controlled by software for gyroplane control, in the form of an application with user interface, installed on a computing device, such as, for example, personal computer, tablet, smartphone or laptop. The computing device with the installed software communicated with the “Pilot Interface” control unit using wireless technology, such as, for example, Bluetooth® technology. Communication between the computing device and the control unit may be realized by means of wired communication. In a graphic user interface of the application, the operation states and data about the electric drive system of the gyroplane are displayed. The software allows controlling the electric motor, regulator, traction battery and the particular elements of the safety equipment, which are a part of the electric drive system. In case the pilot does not have a computing device connectable to the control unit, the control unit is provided with a hardware interface intended for controlling the necessary functions and reporting of the necessary information for safe gyroplane operation. Among the necessary functions belong especially turning the whole system on and off by the pilot using the switcher, setting the size of torque moment, the battery chargé control during flight, displaying the control reports about the operation state of the particular system elements as well as the gyroplane by means of a light control or indicator. Additional information include temperature of the regulator cooler. This information is not necessary for the pilot, as the electric drive system reports possible overheating of the regulator cooler by means of, for example, a control light, and subsequently turns it off securely. The hardware interface includes, for example, switcher and potentiometers, further signaling lights and pointer or digital indicators.

For easy manipulation with the gyroplane during its movement on the ground it is preferred when the electric drive consists of one or more electric motors and at least one regulator, traction battery and “Pilot Interface” type control unit. The traction battery provides electric energy for the regulator, which regulates the current density, which is identifiable or measurable as the overall electric current flowing through the particular conductor into any of the electric motors. An advantage is that the electric motor is also silent and therefore it is very suitable for transporting the gyroplane between the inhabited area and the gyroplane take-off and landing area.

The electric drive system of a gyroplane is designed for both the three-wheel chassis and the four-wheel chassis known in the state of the art. A gyroplane with a four-wheel chassis has mostly seats for passenger arranged next to each other. Further, a light front controllable axle with two driven chassis wheels is arranged in the front part of the gyroplane chassis. The right seat is usually a pilot's seat and control elements for the flight are arranged therein, and in such case, the left seat is intended for the driver, and it is therefore provided with control elements for movement on the ground. The control elements for movement on the ground communicate with the pilot and especially with the electric drive through regulator and other elements necessary for the movement on the ground level.

In particular, the flight control elements include a knob and built-in airborne instruments, which are arranged in the gyroplane already before installation of the gyroplane electric drive. The control elements for movement on the ground comprise the “Pilot Interface” control unit and hardware interface defined above.

Each chassis wheel may be driven by its own electric motor. Therefore, there may be various variants of the embodiment of the electric drive system of a gyroplane solely by choosing which chassis wheels we want to drive. The present solution of the electric drive system of a gyroplane proposes all possible configurations of driving the chassis wheels for three-wheel and four-wheel gyroplanes, which are clearly illustrated in the drawings.

The left-side embodiment is identical with the right-side embodiment, as only one chassis wheel is driven. It is also possible to drive all chassis wheels. Increasing the number of electric motors results in increasing the number of regulators powered by the traction battery. The regulator may be a multi-channel one for connecting more electric motors or more single-channel regulators may be used.

Such proposed electric drive system of a gyroplane comprises an independent drive for movement in air and an independent drive for movement on the roads. The system allows movement of the gyroplane even without using the pusher propeller, not posing risk of injury to the surroundings, and therefore it is possible to operate the present gyroplane on public roads.

### DESCRIPTION OF DRAWINGS

The invention will be further described by means of drawings, in which

FIG. 1 schematically illustrates the electric drive system of a gyroplane comprising the electric motor located outside the axis of the wheels and driving the front chassis wheel,

FIG. 2 schematically illustrated the electric drive system for a gyroplane comprising the electric motor arranged outside the axis of the wheels and driving the rear chassis wheel,

FIG. 3 illustrated a detail of the electric drive consisting of the electric motor mounted on the support structure and gears,

FIG. 4 illustrated a detail of the casing of the driven chassis wheel,

FIG. 5 illustrates the coaxial arrangement of the electric motor in the front chassis wheel,

FIG. 6 illustrates the coaxial arrangement of the electric motor in the rear chassis wheel,

FIG. 7 illustrates a detail of the electric motor embodiment, which is arranged on the common axis with the chassis wheel,

FIG. 8 illustrates the casing of the chassis wheel with the electric motor on the common axis with the chassis wheel,

FIG. 9 illustrates the electric motor, which is arranged in the rim and on the shaft of the front chassis wheel, wherein the transfer of the torque from the electric motor on the driven travelling wheel is realized by means of planetary gearbox,

FIG. 10 illustrates the electric motor, which is arranged in the rim of the rear chassis wheel, wherein the transfer of the torque from the electric motor on the driven travelling wheel is realized by means of planetary gearbox,

FIG. 11 illustrates a detail of the arrangement of the electric motor with the planetary gearbox in the rim of the chassis wheel,

FIG. 12 illustrates the detail of the arrangement of the planetary gearbox and the electric motor in the chassis wheel and

FIG. 13a illustrates a block electric connection of the electric drive system of a gyroplane with a single-channel regulator;

FIG. 13b illustrates a block electric connection of the electric drive system of a gyroplane with a two-channel regulator;

FIG. 13c illustrates a block electric connection of the electric drive system of a gyroplane with four-channel regulator,

FIG. 13d illustrates a block electrical connection of the electric drive system of a gyroplane with a general connection for the regulator;

FIG. 14 illustrates connection alternatives of the driven travelling wheels with a single-channel regulator;

FIG. 15 illustrates connection alternatives of the driven travelling wheels with a pair of single-channel regulators;

FIG. 16 illustrates connection alternatives of the driven travelling wheels with one two-channel regulator;

FIG. 17 illustrates connection alternatives of the driven travelling wheels with four single-channel regulators;

FIG. 18 illustrates connection alternatives of the driven travelling wheels with two two-channel regulators;

FIG. 19 illustrates connection alternatives of the driven travelling wheels with one four-channel regulator;

FIG. 20 illustrates variants of the embodiment of the driven travelling wheels in the electric drive system of a gyroplane and

FIG. 21 illustrates an overview of possible variants of energy transfer from the electric motor to the driven travelling wheel.

### DESCRIPTION OF AN EXEMPLARY EMBODIMENT

The invention will be further described in the following description of an exemplary embodiment of the electric drive system of a gyroplane with reference to the respective drawings. In the said drawings, the present invention is illustrated by means of an exemplary embodiment of the electric drive system for driving the driven travelling chassis wheels of the gyroplane. The examples provided in the description of the application are illustrative.

The electric drive system of a gyroplane 28 may be provided in three variants, which provide solution for transferring the traction energy from the electric motor 1 to the driven chassis wheel 12. In all three variants, the electric drive system of a gyroplane 28 comprises the primary engine 7, which is connected with the pusher propeller 8 for forward movement and further the electric motor 1 for movement on the roads. The gyroplane 28 is also provided with safety elements for movement on the roads.

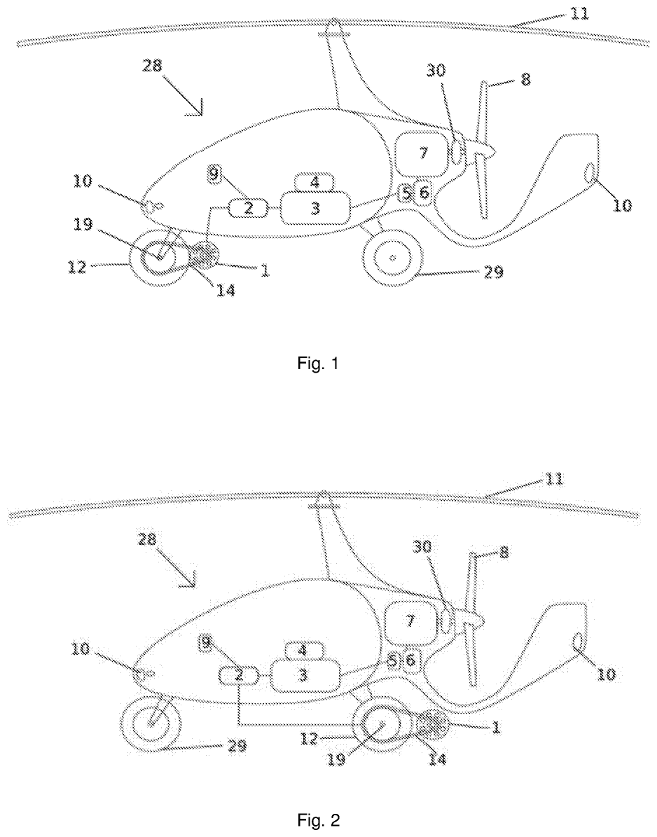

The embodiment of the electric drive of the gyroplane 28, in which the electric motor 1 is arranged on the front or rear chassis wheel 29, is illustrated in FIG. 1 and FIG. 2. The electric drive for the gyroplane 28 comprises the primary engine 7 mechanically connected with the pusher propeller 8, which provides a take-off speed for the gyroplane 28, and further the electric motor 1 for movement on the ground. The primary engine 7, especially a combustion engine, is further connected with the pusher propeller 8 by means of a pulley or a drive belt. Further, the alternator 6, to which the battery 5 is attached, is built in the combustion engine. The battery 5 is connected to the traction battery 3, charging it during flight depending on the charging conditions. The alternator 6 uses the primary combustion engine 7 for its propulsion. The traction battery 3 is connected with the management system 4 of the traction battery 3, which provide safety during operation. The traction battery 3 provides electric energy for the regulator 2, which regulates the current density, which is identifiable/measurable as the overall electric current flowing in the particular conductor into the electric motor 1. The electric motor 1 subsequently forms regulated torque on the driven chassis wheel 12. The torque requirement is defined by a pilot to the regulator 2 pilot, by means of a control unit 9 of “Pilot Interface” type. The gyroplane is further provided with the lights 10 and safety elements, which are required for secure movement on the public roads, wherein all these elements are also controlled by means of the “Pilot Interface” type control unit 9.

Embodiment of the electric drive of the gyroplane 28, in which the electric motor 1 is arranged outside the driven chassis wheel 12, is illustrated in FIG. 2. In this embodiment, the electric drive comprises the electric motor 1 arranged outside the axis of the shaft 19 of the driven wheel 12. The torque formed by the electric motor 1 is transferred through the belt 14 and the gear, being formed by small and large pulleys 17 and 16, wherein the large pulley 16 is arranged on the shaft 19 of the driven wheel 12, while the small gear wheel 18 is attached on the shaft of the electric motor 1.

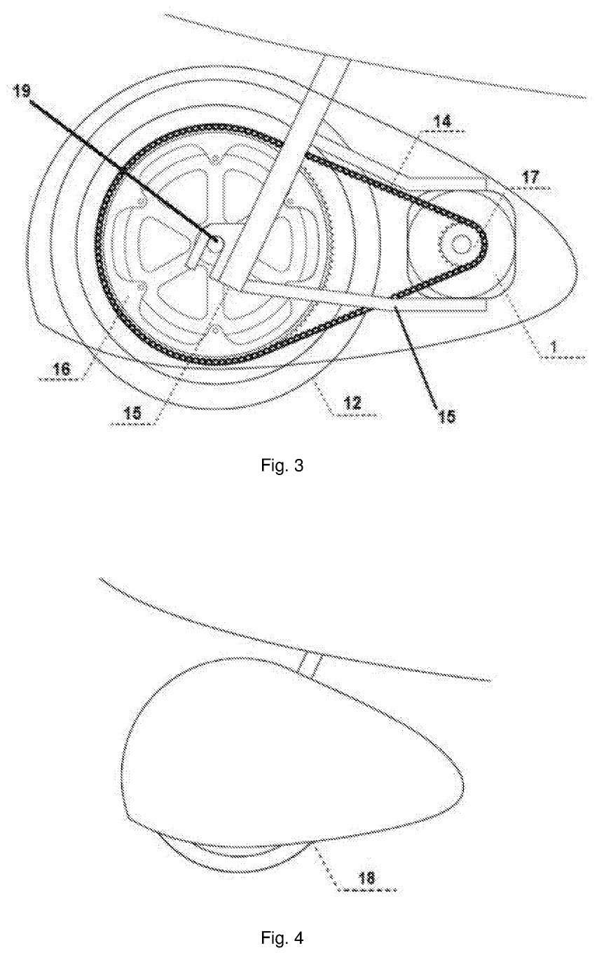

Detail of the electric motor 1 arrangement outside the driven chassis wheel 12 is illustrated in FIG. 3. In this embodiment, the electric motor 1 is arranged outside the axis of the shaft 19 of the driven chassis wheel 12, attached in the axle 15. The electric motor 1 is arranged in the support structure 13, which is firmly coupled with the axle 15. The torque is transferred from the electric motor 1 to the driven travelling wheel 12 by means of the gear and the belt 14, as it is described in the paragraph above. In this arrangement of the electric motor 1, the electric motor with higher nominal speeds than the nominal speeds of the driven chassis wheel 12 is used, wherein the speeds are reduced to the driven chassis wheel 12 by means of gear. Therefore, it might be concluded that during operation, the speeds of the electric motor 1 range between, for example, 0 and approximately 2500 rpm, wherein the speeds of the driven travelling wheel 12 range between 0 and approximately 500 rpm. This asymmetry is compensated by means of gear ratio determined by the difference of the radius of the pulleys. The rates of the driven wheel are defined by the maximum speed and its radius. The razes of the electric motor are determined by evaluation of various physical facts when selecting the motor.

Therefore, it is possible to use an electric motor with a lower weight. For increasing aerodynamics of the chassis, the driven travelling chassis wheel 12 as well as the electric motor 1 together with the support structure 13 housed in the casing 18, as it is illustrated in the FIG. 4.

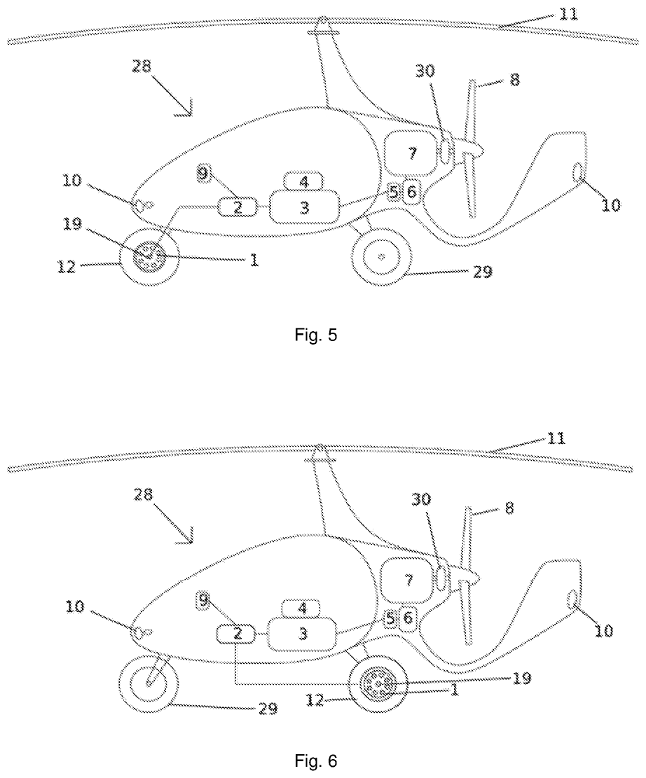

Another variant of the electric drive system of a gyroplane 28 with direct drive, in which the electric motor 1 is arranged on the front or the rear chassis wheel 12, is illustrated in the FIG. 5 and FIG. 6. In this embodiment, the electric motor 1 is arranged on the shaft 19 of the driven chassis wheel 12.

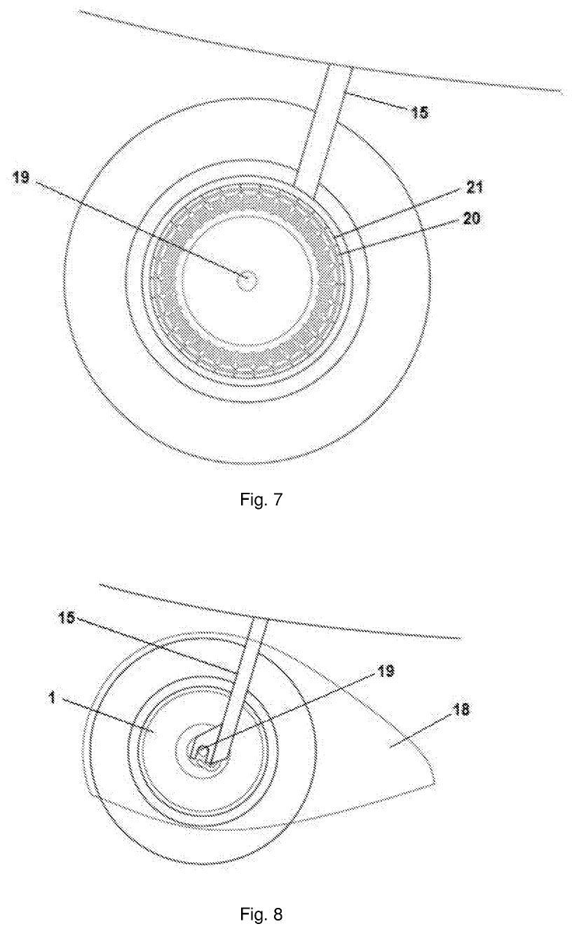

A detail of the electric drive structure, wherein the electric motor 1, driving the driven chassis wheel 12 and being arranged on the common axis with the shaft 19 is illustrated in the FIG. 7 and FIG. 8. In this embodiment, the driven chassis wheel 12 comprises the rotor 21, which is a part of the hub of the driven wheel and the stator 20, which is a part of the rim 23 of the driven chassis wheel 12. Such electric motor 1 generates torque and moves the rim 23. The arrangement of the electric motor 1 on the axis of the shaft 19 of the driven chassis wheel 12 secures gear of 1:1. For increasing aerodynamics of the chassis, the driven chassis wheel 12 as well as the electric motor 1 provided with the casing 18, as it is illustrated in the FIG. 8.

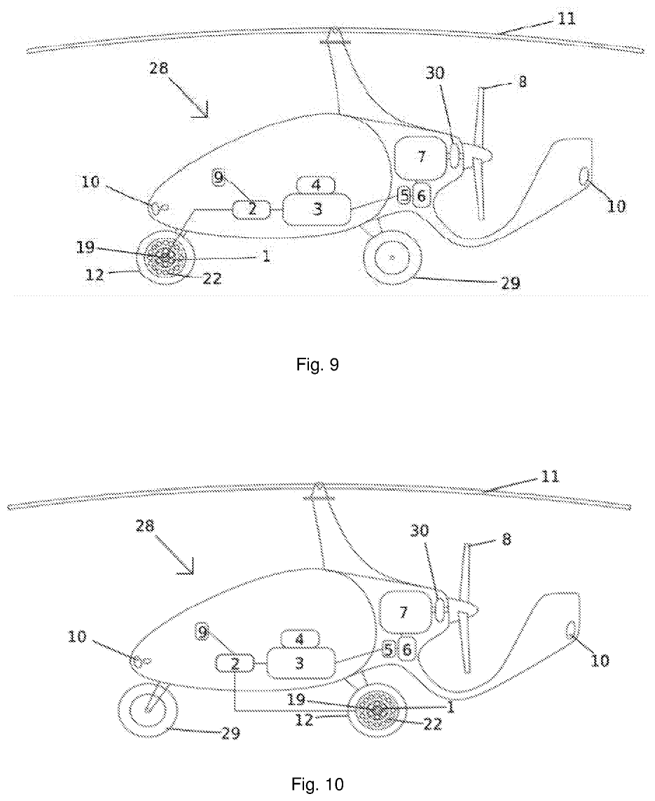

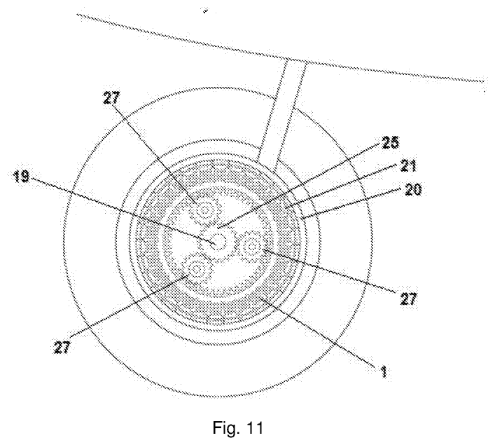

Another variant of the electric drive of the gyroplane 28, in which the electric motor 1 is arranged on the front and the rear driven chassis wheel 12 with direct drive, is arranged in the FIG. 9 and the FIG. 10. In this embodiment of the electric drive, the driven chassis wheel 12 comprises the rotor 21, which is a part of the hub of the driven wheel 12 and the stator 20, which is a part of the rim 23 of the driven chassis wheel 12. The electric motor 1 is arranged on the axis of the shaft 19 of the driven chassis wheel 12. Transfer of the torque to the driven chassis wheel 12 is realized by means of the planetary gearbox 22. The planetary gearbox 22 secures the defined gear ratio as “slow down”. In this embodiment, the electric motor 1 with higher speeds than the speeds of the driven chassis wheel 12 is used, wherein by means of the “slow down” gear, the speeds are reduced to the driven chassis wheel 12. It thus possible to use the electric motor 1 with a lower weight.

As long as the electric motor provides the same performance with higher speeds, its weight will be lower, as majority of its components will be of smaller dimensions, such as the rotor, shaft, the gearbox, etc. In comparison to the solution of the direct drive, the resulting solutions of the high-speed motors have smaller weights even after including the weight of the reducing planetary gearbox.

A detail of the structure of the electric drive, in which the electric motor 1, which drives the driven chassis wheel 12 and which is arranged on the common axis with the shaft 19, is illustrated in the FIG. 11. In this embodiment, the driven chassis wheel 12 comprises the rim 23 with the tire 24. Inside the hub of the driven chassis wheel 12, the planetary gearbox 22 and the electric motor 1 are arranged. The electric motor 1 generates torque, which sets the planetary gearbox 22 in motion and increases the gear ratio between the electric motor 1 and the rim 23 of the driven chassis wheel 12. The electric drive further comprises temperature and speed sensors, which communicate with the regulator 2, which evaluates data and adjusts the electric current, which is identifiable/measurable as the overall electric current flowing between the particular conductors from the traction battery 3 into the electric motor 1.

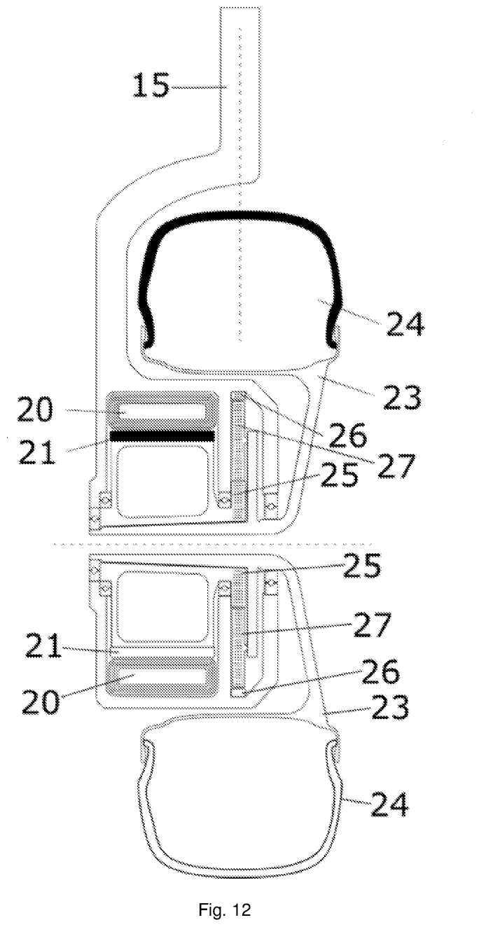

The arrangement of the planetary gearbox 22 together with the driven chassis wheel 12 is illustrated in the FIG. 12. The driven chassis wheel 12 forms the rim 23 provided with a tyre 24. The rim 23 is firmly and rotatably connected with the axle 15. The electric motor 1, comprising the stator 20 and the rotor 21 is rotatably arranged in the hub of the driven chassis wheel 12. The planetary gearbox 22 consists of the central wheel 25 mounted on the hub, which is arranged on the shaft 19. The central ring 25 engages with the satellites 27. These satellites 27 further engage with the ring gear 26 arranged on the rim 23. The electric motor 1 has the rotor 21 firmly connected with the central ring 25.

For all variants of arrangement of the electric drive system of a gyroplane 28 the electric motor 1, which is arranged on the driven chassis wheels 12, and other components of the system are designed in the same manner. The particular variants of the electric drive system of a gyroplane allow to power or all gyroplane travelling wheels 12. For all these variants of the drive of travelling wheels 12, it is necessary to choose suitable connection of the regulators 2.

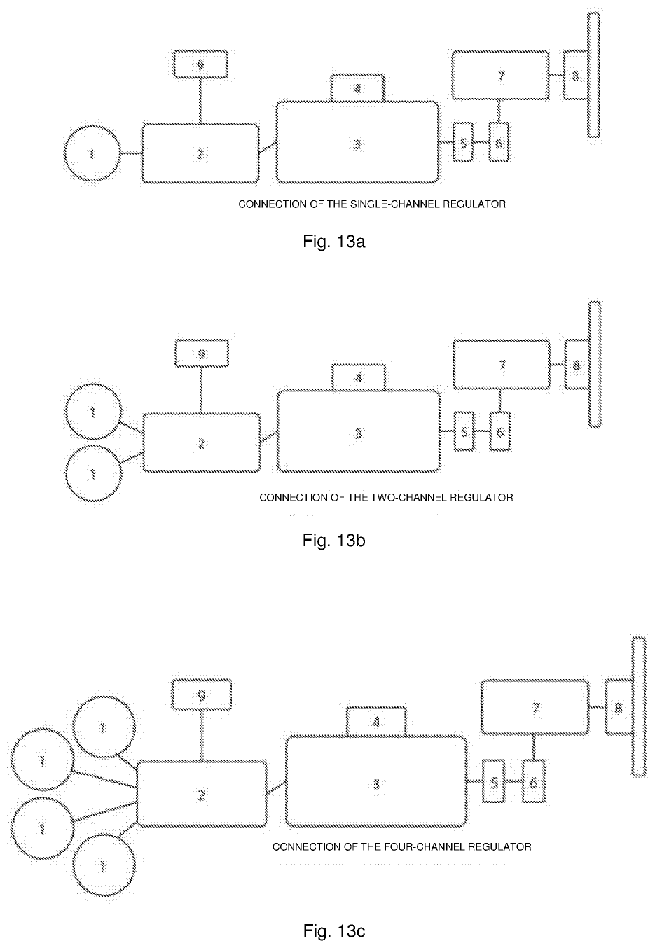

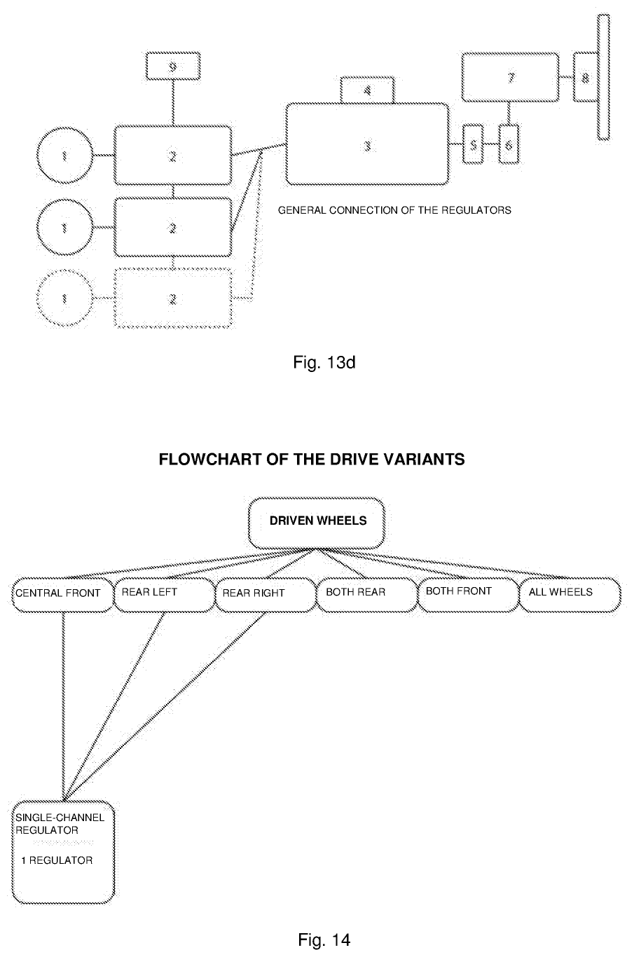

The FIG. 13d illustrates general connection of the regulators 2 in the electric drive system of a gyroplane, wherein the FIG. 13a illustrates connection of the single-channel regulator 2 in the electric drive system of a gyroplane for driving one travelling wheel 12. The FIG. 13b illustrates connection of the two-channel regulator 2 in the electric drive system of a gyroplane for driving two travelling wheels 12. The FIG. 13c illustrates connection of the four-channel regulator 2 in the electric drive system of a gyroplane for driving four travelling wheels 12.

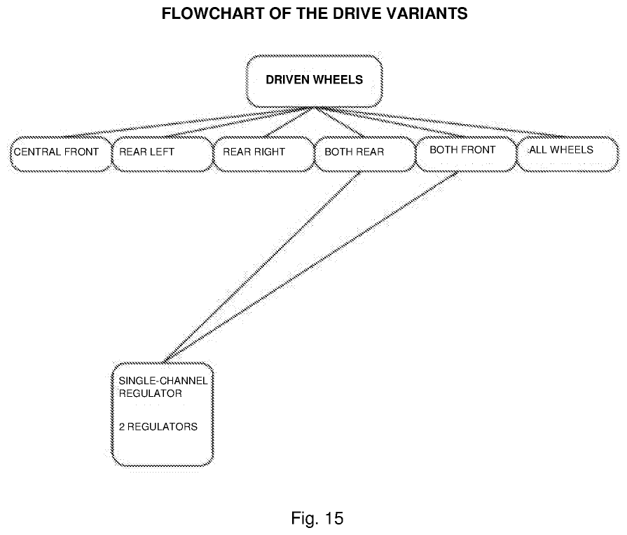

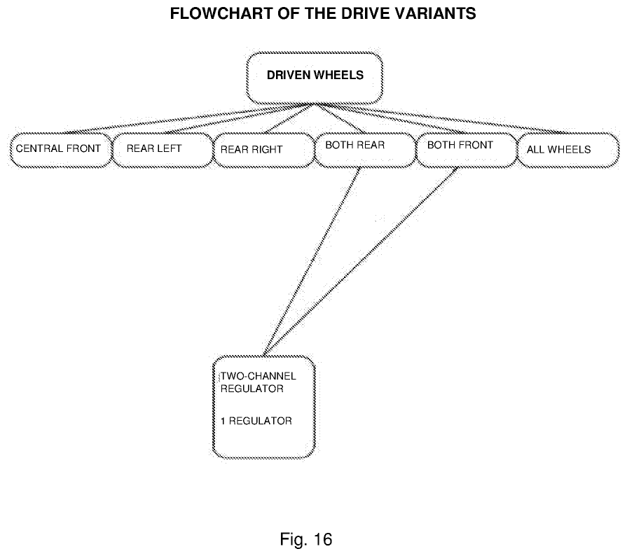

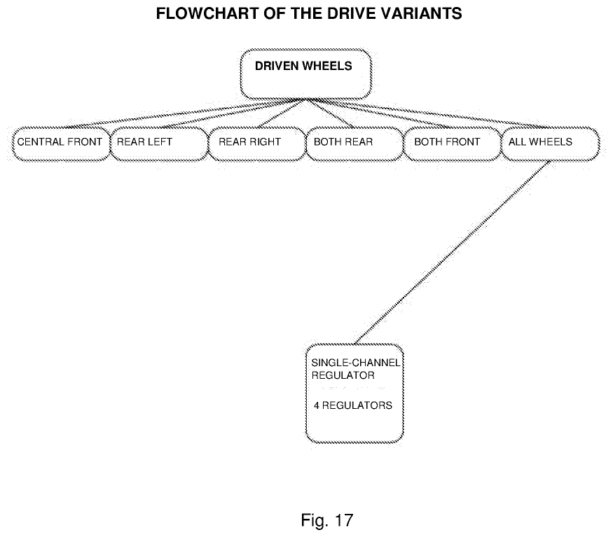

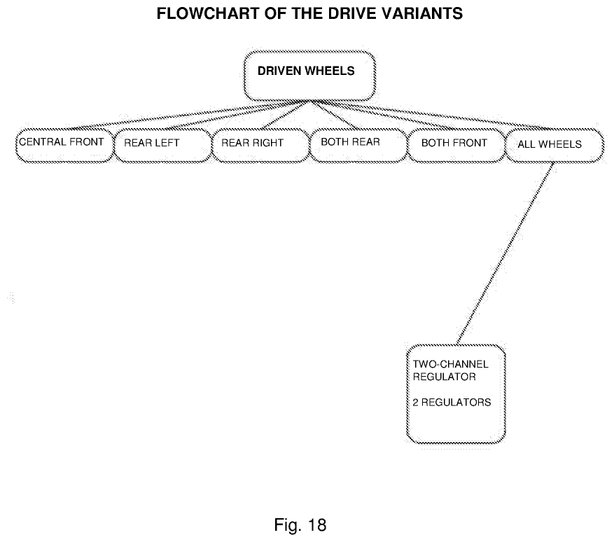

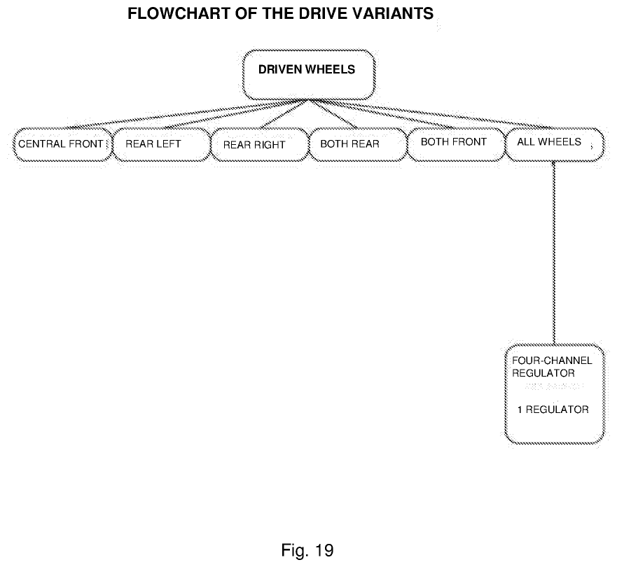

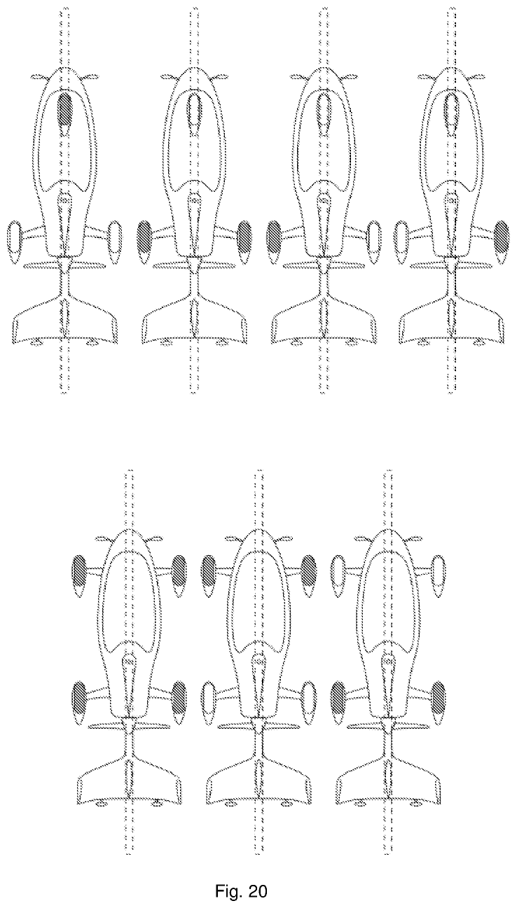

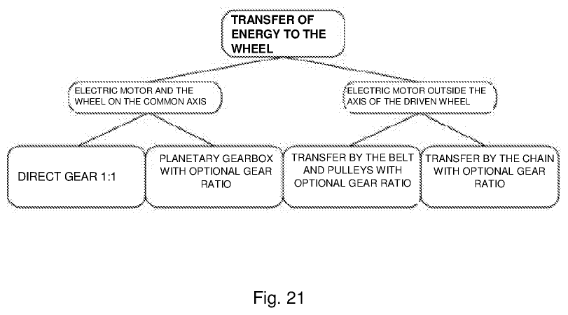

The FIG. 14 illustrates possible variants of controlling one travelling wheel 12 by means of one single-channel regulator 2. The FIG. 15 illustrates possible variants of controlling two travelling wheels 12 by means of two single-channel regulators 2. The FIG. 16 illustrates possible variants of controlling two travelling wheels 12 by means of one two-channel regulator 2. The FIG. 17 illustrates possible variants of controlling four travelling wheels 12 by means of four single-channel regulators 2. The FIG. 18 illustrates possible variants of controlling four travelling wheels 12 by means of two two-channel regulators 2 and the FIG. 19 illustrates possible variants of controlling four travelling wheels 12 by means of one four-channel regulator 2. The FIG. 20 illustrates variants of the particular driven travelling wheels 12 in three-wheel and four-wheel gyroplane. An overview of variants of transferring the electric energy from the electric motor 1 to the driven travelling wheel 12, according to the embodiment type of the electric motor, as it is illustrated in the FIG. 21.

The electric drive system of a gyroplane according to the present invention allows performance of at least two functions, so called discontinuous or partially continuous operation.

For powering the electric motor 1, the discontinuous operation uses only the energy stored in the traction battery 3, which is able to store and transfer energy in kilowatt hour units, wherein the primary engine 7 does not need to be in operation. The operation time is limited by the amount of energy stored in the traction battery 3 and the driving style. The traction battery 3 is being recharged during the flight and the primary engine 7 is in operation, wherein the alternator 6 provides electric energy for the charger 5, charging the traction battery 3 in conjunction with the battery management system 4.

The continuous operation, as meant herein, uses mostly energy produced in real time by means of the primary engine 7 connected with the alternator 6 and power-rated identically to the primary engine 1, to power the electric motor 1. During continuous operation, there is no need to use the traction battery 3. The operation time is not limited, the electric drive is able to remain in operation as long as the primary engine 7. The electric drive system for a gyroplane in continuous operation allows legal movement on the road only provided that the pusher propeller 8 is disconnected from the primary motor 1. The disconnection of the pusher propeller 8 from the primary engine 7 may be realized by means of an ordinary detachable coupling 30. The detachable coupling 30 and its usage for mutual connection and disconnection of mechanical components is well-known and therefore it is not illustrated in the drawings in detail.

Continuous or discontinuous operation allows connection of the particular parts of the electric drive for a gyroplane according to the present invention, which is schematically illustrated in the FIG. 13a, FIG. 13b, FIG. 13c and FIG. 13d. The primary engine 7, especially a combustion engine, is mechanically connected to the alternator 6, which is further electrically connected with the charger 5. The charger 5 is further coupled to the traction battery 3, charging it during flight according to the pilot's settings, using the energy from primary combustion engine 7. The traction battery 3 is further connected with the battery management system 4, which provides safety during its operation. The traction battery 3 is further electrically connected to the regulator 2, which communicates bi-directionally with the control unit “Pilot Interface” type control unit 9. The regulator 2 is further coupled to the electric motor 1 and regulates its operation according to the requirements of the “Pilot Interface” type control unit 9.

### INDUSTRIAL APPLICABILITY

Technical solution of an electric drive for gyroplanes is intended for legal movement of the gyroplane on the road.

### LIST OF REFERENCE SIGNS

1—electric motor
2—regulator
3—traction battery
4—Battery Management System
5—charger
6—alternator
7—primary motor
8—pusher propeller
9—“Pilot Interface” control unit
10—lights
11—support rotor
12—driven chassis wheel
13—support structure
14—pulley
15—axle
16—large pulley
17—small pulley
18—casing
19—shaft
20—motor stator
21—motor rotor
22—planetary gearbox
23—rim
24—tire
25—central ring
26—gear ring
27—satellite
28—gyroplane
29—chassis wheel
30—detachable coupling

1. An electric drive system of a gyroplane (28) comprising a support motor (11) and a primary engine (7) connected with a pusher propeller (8) for movement in air and an electric motor (1) for movement on the roads, characterized in that the primary engine (7) is connected by means of mechanical gear to an alternator (6), which is connected to a charger (5), which is connected to a traction battery (3), wherein the traction battery (3) is bi-directionally coupled with a battery management system (4), wherein the traction battery (3) is further electrically connected with a regulator (2) and a control unit (9), while the regulator (2) is further connected with the electric motor (1), mounted on a driven chassis wheel (12), which is driven by the electric motor.

2. The electric drive system of a gyroplane according to claim 1 characterized in that it has the primary engine (7) connected by means of a detachable coupling (30) with the pusher propeller (8).

3. The electric drive system of a gyroplane according to claim 1 characterized in that it has the alternator (6) power-rated identically with the electric motor (1).

4. The electric drive system of a gyroplane according to claim 1 characterized in that the electric motor (1) is arranged in a support structure (13), which is firmly connected with an axle (15), wherein the electric motor (1) is provided with a small pulley (17) and connected with the driven chassis wheel (12) by means of a belt (14) or chain.

5. The electric drive system of a gyroplane according to claim 1 characterized in that the electric motor (1) is arranged coaxially in a rim (23) of the driven chassis wheel (12), wherein a planetary gearbox (22) is further arranged in the rim (23).

6. The electric drive system of a gyroplane according to claim 1 or characterized in that the electric motor (1) and the driven wheel (12) are arranged in a casing (18).

7. The electric drive system of a gyroplane according to claim 1 characterized in that the control unit (9) is provided with WiFi or Bluetooth® wireless communication technology, wherein these technologies may be combined.

8. The electric drive system of a gyroplane according to claim 4 characterized in that the electric motor (1) and the driven wheel (12) are arranged in a casing (18).

9. The electric drive system of a gyroplane according to claim 5 characterized in that the electric motor (1) and the driven wheel (12) are arranged in a casing (18).
